(19) United States
(12) Patent Application Publication
(10) Pub. No.: US 2004/0014468 A1
(43) Pub. Date: Jan. 22, 2004

(54) Mobile system for access to and visualisation of standard internet contents and services

(76) Inventor: Alex Walling, Enskede Gard (SE)

Correspondence Address: Stephen A Soffen, Dickstein Shapiro Morin & Oshinsky, 2101 L Street NW, Washington, DC, 20037-1526, US

(21) Appl. No.: 10/398,562

(22) PCT Filed: Oct. 10, 2001
(86) PCT No.: PCT/SE01/02204

(30) Foreign Application Priority Data
Oct. 10, 2000 (SE) 0003653-3

(51) Int. Cl. H04Q 7/20

(52) U.S. Cl. 455/422.1; 455/424; 455/566

(57) ABSTRACT

The invention relates to a mobile system for access to and visualisation of standard Internet contents and/or services. The system comprises terminals cooperating with a communication central 5 via some mobile network adapted for wireless data communication. The system is characterised in that the mobile terminals 1 are connectable to a printing device 11, that the communication central 5 is connected to the Internet 27, and that in said communication central 5a for the purpose intended stored software application transforms the by the user requested Internet contents and/or services to one or more print file(s). The file(s) are thereafter wirelessly sent to said printing device 11, whereby the users are able to print said print file(s) without having the program applications stored in the mobile terminals 1.

### FIELD OF THE INVENTION

The invention relates to a mobile system of the kind apparent from the preamble of patent claim 1.

The invention thus relates to a mobile system of the kind used for wireless data communication between handheld mobile terminals, terrestrial base stations and further to fixed telephone connections, Internet/intranet servers or other mobile terminals.

### BACKGROUND OF THE INVENTION

The wireless environment creates totally different requirements for the displaying of information, than the fixed or stationary environment. The demand of mobility puts high requirements in the dimensioning of the mobile terminals and associated graphical screens. These are generally too small to be able to display standard data contents from the Internet in a satisfying way.

New protocols have been put forward to enable “optimisation” of Internet contents for the small screens of the data terminals. This optimisation consists in principle in a substantial downsizing of information, so that it fits into the small screens. WAP (Wireless Application Protocol) is one such protocol developed just for following the restrictions in the wireless environment.

Other restrictions besides the size of the screen, is that Internet standard, such as HTTP and TCP, is not adapted for intermittent coverage, long waiting time and limited bandwidth that are characterising for wireless environments.

HTTP sends its commands in an inefficient text format instead of compressed binary format.

Another major problem that the wireless systems face is that an increasing part of the information on the Internet is presented in file formats other than web browser friendly formats (HTML, XML, GIF, JPG, etc.). Examples of these more and more common file formats are PDF, DOC, XLS, TIFF, EPS, and also file formats handled by special so called “plug-ins”, or additional programs to the web browsers. These different file formats require that special applications be installed in the receiver's terminal, which places high demands on memory space, processing capacity etc. Wireless terminals can not reasonably handle all these applications, and even if they could, their screens would not be able to display the contents in a satisfactory manner.

### SUMMARY OF THE INVENTION

The invention has thus an object to provide a mobile system comprising mobile terminals, so that standard optional Internet contents and services can be obtained and visualised regardless of the user's location.

The object is achieved with a mobile system according to the accompanying claim 1.

Additional objects of the invention are apparent directly or indirectly in the following.

By having a mobile terminal provided with a printing device one is able to present information on considerably larger areas than is available with small screens. In addition the information becomes clearer on a printout surface than on a computer screen.

The only file format that such a terminal needs to be able to handle is PRN, or so called print files. The transformation from all existing file formats on the Internet to print files is accomplished at a server level. This allows the hardware and software structure of the mobile terminals to become very simple and the manufacturing costs can be kept low. The servers can on the contrary be very powerful, with the necessary applications stored thereon, the applications being needed for interpretation of all existing file formats.

The proposed mobile system can be move extremely flexible by allowing representation of inquiries via any existing communication method. It is only the answers to the inquiries that are delivered in the form of print files. Conceivable ways to make inquiries are for example via WAP, SMS, WEB or also via regular phone calls. Inquiries can also be of a latent character that becomes active as soon as a certain event occurs. Examples of this kind of inquiries are forwarding of E-mail, fax messages in form of attachments to E-mail messages, newsletters and so forth.

Embodiments of the inventive system are stated in the attached dependent claims.

The invention will in the following be described by way of examples with reference to the attached drawings.

### BRIEF DESCRIPTION OF THE DRAWINGS

FIG. 1 shows a schematic view of a separate mobile terminal with a built-in unit for wireless long range data communication with terrestrial base stations and further to and from a communication central adapted for a mobile system according to the invention.

FIG. 2 shows another embodiment of a mobile terminal with a built-in unit for wireless long range data communication with other equivalent terminals, which in addition are equipped with a unit for wireless long range data communication with terrestrial base stations.

FIG. 3 shows a schematic view over a communication central, its various components and the software configuration for a mobile system according to the invention.

FIG. 4 shows a schematic view over the processes in a mobile communication system shown in FIG. 3.

### DETAILED DESCRIPTION OF PREFERRED EMBODIMENTS

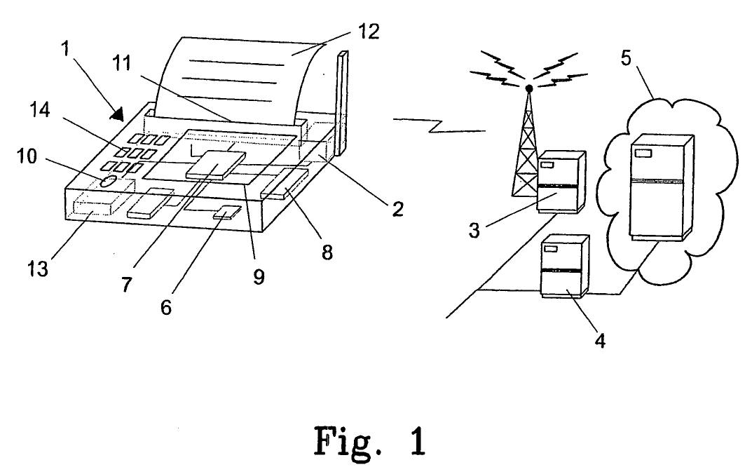

In FIG. 1 a mobile terminal (1) is shown, consisting of a communication unit (2) intended for wireless data communication with a terrestrial base station (3) through a base station controller (4) to and from a communication central (5). The invention is not limited to wireless communication with a terrestrial base station (3), wireless communication using a satellite works equally well. In that case the mobile terminal (1) communicates with a satellite, which in turn communicates with a terrestrial base station.

The mobile terminal (1) has a SIM module (6) for identification of the user, a data processor or micro controller (7) controlling all processes in the mobile terminal (1), a memory unit (8) for storage of incoming data, a graphical screen (9) for visualisation of incoming print files, a sound module (10) giving a warning signal about incoming print files. One of the most important features of the mobile terminal (1) is a printing device (11) that see to it that incoming print files are transferred to a printout surface (12). Other parts of the mobile terminal (1) is an energy source in the form of a battery (13) and a set of command buttons (14) intended for the control of the different functions of the mobile terminal (1).

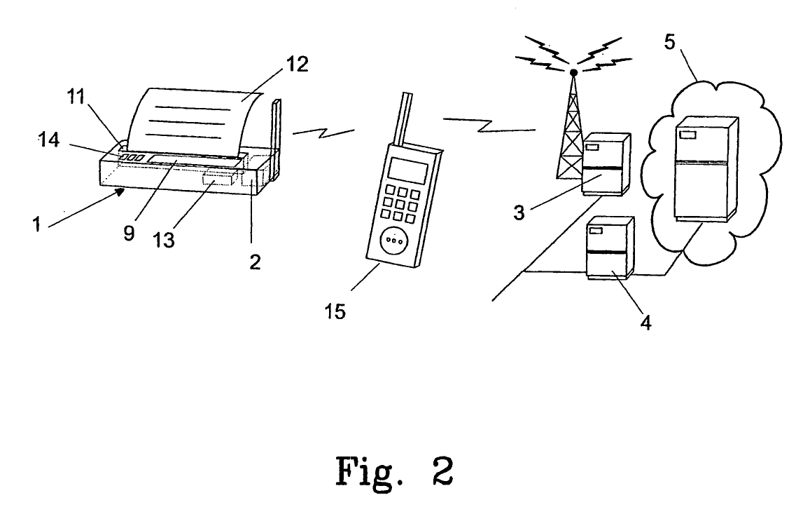

In FIG. 2 a mobile terminal (1) is shown, consisting of a communication unit (2) intended for wireless data communication with another mobile terminal (15), the other mobile terminal (15) in addition being able to receive data from a terrestrial base station (3) (or able to communicate with a satellite) that is coupled to a communication central (5) through a base station controller (4).

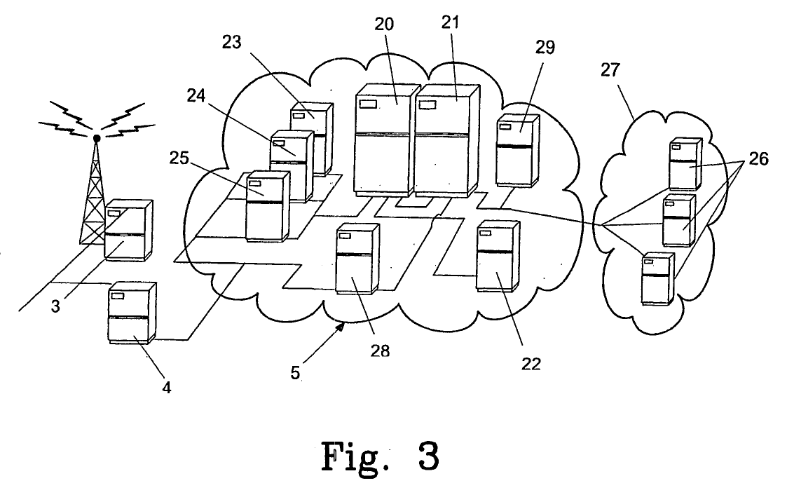

In FIG. 3 a communication central (5) is shown consisting of a server part (20), a client part (21), a WAP bridge (23), a SMS bridge (24), a voice controlled interface (25), a data base (22), a POP-server part (29) and a transformation unit (28).

The user sends an inquiry about a certain web site, file or service being found on the Internet (27) to the communication central (5). The inquiry can be made in different ways. By WAP, SMS, WEB or even by placing a regular wired phone call, using the public service telephone network (PSTN). Depending on which type of these communication channels that is used, the inquiry passes via one of the different bridges or interfaces (23, 24, 25) to the server part (20) that identifies the sender via SIM based calling line identification, IP number or some other in advance established method. In a data base (22) information about the user's terminal type, personal configuration, and also any for the purpose relevant information, is stored. The bridges (23, 24, 25) have the purpose of converting the inquiries from different protocols, such as WAP or MAP to Internet adapted protocols such as HTTP, TCP or FTP. The inquiries are passed to the client part (21) and further on to the server or servers (26) on the Internet (27) where the current web site, file or service are stored. The inquired information is then taken to the client part (21) in the communication central (5) via the respective protocol, and is then sent to the transformation unit (28). This transformation unit (28) is equipped with applications to enable opening and reading of all conceivable and existing file formats, for then being able to print the result to a print file specially adapted for the user's mobile terminal (1). Examples of such applications would be applications able to read PDF-files (for example Acrobat Reader), HTML-files (for example Internet Explorer) and text files (for example Word). The print file is compressed and optionally encrypted, for thereafter being sent via a base station (3) (and possibly via a satellite) to the user's mobile terminal (1).

In the POP-server part (29) the user's personal E-mail messages that may even contain fax messages and other content in the form of attachments. The user may configure his/her account, so that incoming messages are transformed to print files and sent to the user's mobile terminal (1) for printout as soon as they arrive to the POP-server part (29), or the account may be configured so as the user decides when he or she wants to download his/her messages. The POP-server part need not be positioned within the communication central (5), but the user may access external POP-servers as well.

The information about such, or some other, configuration is stored in the data base (22). The user's information inquiry may consist of the e-mails in a user's mailbox at work for example, and in this case passwords and other necessary information may be stored in the database (22). In this way the user does not have to enter several passwords. Once the user has entered a password (a PIN code for example) and been authenticated by means of the mobile terminal (1), the user may access all kinds of information retrieval sources (work mailboxes or other external POP-servers for example) that he or she has registered in the data base (22). This registration, or rather information entering, to the data base (22) can be performed in a number of ways, such as for example through a web site, an SMS service, an E-mail, a letter or a phone call.

The requested information or service may be accessed from various resources, such as for example web sites on the Internet, electronic mail or unified messaging servers, fax servers, online databases accessed through the Internet, telephone networks, satellites, wired or wireless or any combination thereof. The information or service that the user requests may also be stored within the communication central (5). The user may for example wish to print his/her current settings in the database (22).

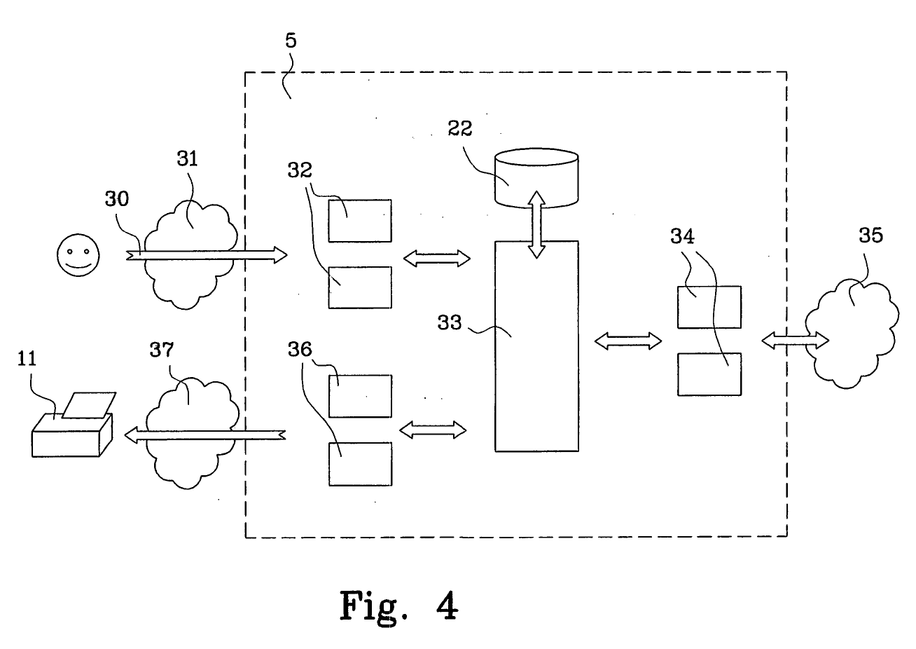

FIG. 4 shows a view over the processes in a mobile communication system described in connection with FIG. 3. Reference to corresponding or same units as in the previous figures has the same reference numeral when possible. When the user wishes to retrieve some information from some source to his or her printing device (11), preferably mobile, he or she sends a request (30) over some communication network (31) to the communication central (5). The communication network (31) may, as described above, be any network, as for example SMS, WAP, Internet or telephone. The communication central (5) includes several interface units (32) (corresponding to the bridges (23)-(25) in FIG. 3), for receiving the print orders from the communication networks (31). The received order is thereafter processed by a central unit (33) in the communication central (5). The user's identity is authenticated by means of a database (22) containing the user profiles. The central unit (33) uses various interface units (34) for accessing information from external resources through various communication networks (35), which can, as described above, be web sites on the Internet, electronic mail or unified messaging servers, fax servers, online databases accessed through the Internet, telephone networks, satellites, wired or wireless or any combination thereof. If the user for example wishes to retrieve electronic mail, the interface unit (34) thus consists of a mail agent (corresponding to the POP-server (29) in FIG. 3). The information thus retrieved is compiled and formatted in the central unit (33) for enabling printing of the requested print file to the user's printing device (11), preferably mobile, which step was described above in connection with FIG. 3, and more specifically when describing the transformation unit (28). The communication central (5) has several interface units (36) (again corresponding to the bridges (23)-(25) in FIG. 3) for enabling delivery to the user's printing device (11), preferably mobile, over various communication networks (37). The print file is thus printed at the user's printing device (11), which preferably is mobile.

1. A mobile system for access to and visualisation of standard Internet contents and/or services comprising mobile terminals cooperating with a communication central via some mobile network adapted for wireless data communication, characterised in that the mobile terminals (1) contain some form of built-in or separate printing device (11), that the communication central (5) is connected to the Internet (27), and that in the communication central (5) a for the purpose intended stored software application transforms the by the user requested Internet contents and/or services to one or more print files that are thereafter wirelessly sent to a user's mobile terminal, whereby the mobile terminals (1) are able to print said print files without having the program applications stored in the mobile terminals (1).

2. Mobile system as claimed in claim 1, wherein a data base (22) is established for identification purposes, that the data base (22) contains information left or collected by the user and that this information thereafter is used to deliver customised contents to relevant users.

3. Mobile system as claimed in any of the preceding claims, wherein the inquiries about Internet contents or/and services can be made from a WAP adapted mobile terminal (15) via an associated WAP-bridge (23) connected to the communication central (5).

4. Mobile system as claimed in any of the preceding claims, wherein inquiries about Internet contents or/and services can be made from a mobile terminal (15) via a SMS service with an associated SMS-bridge (24) connected to the communication central (5).

5. Mobile system as claimed in any of the preceding claims, wherein inquiries about Internet contents or/and services can be made from a mobile terminal (15) via a voice controlled interface to the communication central (5).

6. A method for access to and visualisation of standard Internet contents and/or services characterised in that requested Internet contents and/or services are transformed by a for the purpose intended software application, stored in a communication central (5), to one or more print files, and that these are thereafter wirelessly sent to a special mobile terminal (1) with a built-in or separate printing device (11), whereby the mobile terminals (1) are able to print said print files terminals (1).

7. Method as claimed in the preceding claim, wherein inquiries about Internet contents can be made by means of an SMS-service where one writes a SMS-message containing a web address, search term or some similar inquiry, that the message is then sent to a communication central (5) via a SMS-bridge (24) and that answers to the inquiries are sent to the user's mobile terminal (1) in the form of a print file.

8. Method as claimed in claim 6, wherein inquiries about Internet contents can be made by means of a for the purpose intended WAP portal, that the inquiries reach a communication central (5) via a WAP-bridge (25) and that answers to the inquiries are sent to the user's mobile terminal (1) in the form of a print file.

9. Method as claimed in claim 6, wherein inquiries about Internet contents can be made by means of an ordinary phone call, that the inquiries reach a communication central (5) via a voice controlled interface (26) and that answers to the inquiries are sent to the user's mobile terminal (1) in the form of a print file.

10. A mobile system for access to and visualisation of standard Internet contents and/or services comprising mobile terminals cooperating with a communication central via some mobile network adapted for wireless data communication, characterised in that the mobile terminals (1) are connectable to a printing device (11), that the communication central (5) is connected to the Internet (27), and that in said communication central (5) a for the purpose intended stored software application transforms the by the user requested Internet contrntl and/or services to one or more print file(s), that are thereafter wirelessly sent to said printing device (11); whereby the users are able to print said print files without having the program applications stored in the mobile terminals (1).

11. Mobile system as claimed in claim 10, wherein the print files are sent via the mobile terminals (1) to the printing device (11).

12. Mobile system as claimed in claim 10, wherein the print files are sent directly to the printing device (11).

13. Mobile system as claimed in claim 11 or 12, wherein said printing device (11) is built-in in said mobile terminal (1).

14. Mobile system as claimed in claim 11 or 12, wherein said printing device (11) is separate from said mobile terminal (1).

15. Mobile system as claimed in any of claims 10-14, wherein a data base (22) is established for identification purposes, that the data base (22) contains information left or collected by the user and that this information thereafter is used to deliver customised contents to relevant users.

16. Mobile system as claimed in any of claims 10-15, wherein the inquiries about Internet contents or/and services can be made from a WAP adapted mobile terminal (15) via an associated WAP-bridge (23) connected to the communication central (5).

17. Mobile system as claimed in any of claims 10-16, wherein inquiries about Internet contents or/and services can be made from a mobile terminal (15) via a SMS service with an associated SMS-bridge (24) connected to the communication central (5).

18. Mobile system as claimed in any of claims 10-17, wherein inquiries about Internet contents or/and services can be made from a mobile terminal (15) via a voice controlled interface to the communication central (5).
